(19) United States
(12) Patent Application Publication
(10) Pub. No.: US 2025/0245508 A1
(43) Pub. Date: Jul. 31, 2025

(54) SYSTEMS AND METHODS FOR TRANSFORMER-BASED GENERATIVE AI APPROACH FOR DYNAMIC EMBEDDINGS

(71) Applicant: Walmart Apollo, LLC, Bentonville, AR (US)

(72) Inventors: Fei Ye, San Carlos, CA (US); Shihui Jia, Cupertino, CA (US); Hui-Min Chen, Pleasanton, CA (US)

(21) Appl. No.: 19/001,220

(22) Filed: Dec. 24, 2024

Related U.S. Application Data
(60) Provisional application No. 63/627,232, filed on Jan. 31, 2024.

(51) Int. Cl. G06N 3/088; G06N 3/045

(52) U.S. Cl. CPC G06N 3/088; G06N 3/045

(57) ABSTRACT

In various embodiments, systems and methods of generating embeddings using transformer-based generative AI processes are disclosed. A sequence dataset is received and a feature dataset including a plurality of feature sets and a temporal position encoding dataset including a plurality of individual encoding sets is extracted from the sequence dataset. Each of the plurality of feature sets are concatenated with a corresponding one of the plurality of individual encoding sets to generate a concatenated feature set. An embedding generation model is implemented to generate an embedding based on the concatenated feature set. The embedding generation model comprises a sparse self-attention mechanism. The embedding is stored in an embedding store.

### CROSS-REFERENCE TO RELATED APPLICATIONS

This application claims benefit under 35 U.S.C. § 119(e) to U.S. Provisional Appl. Ser. No. 63/627,232, filed Jan. 31, 2024, entitled “Systems and Methods for Transformer-Based Generative AI Approach for Dynamic Embeddings,” the disclosure of which is incorporated herein by reference in its entirety.

### TECHNICAL FIELD

This application relates generally to embedding generation, and more particularly, to embedding generation using generative artificial intelligence.

### BACKGROUND

In machine learning, an embedding is a relatively low-dimensional space translation of a high-dimensional vector or element. Embeddings may include dense numerical representations of real-world objects and/or relationships. Embeddings are used in machine learning as inputs to additional models and/or as the basis of one or more operations, such as similarity comparisons, classification, clustering, etc. Current processes for generation of embeddings utilize direct translations or conversions, such as Word2Vec models.

However, simple aggregation for generation of embeddings, such as those implemented by current embedding generation models, result in information loss. In some instances, certain features and/or parameters may be masked, hidden, or otherwise lost during translation from a dataset into an embeddings. Irregular data, complex interactions, and other data relations may be lost by simple generation of embeddings utilizing some current processes.

### SUMMARY

In various embodiments, a system including a non-transitory memory and a processor communicatively coupled to the non-transitory memory. The processor is configured to read a set of instructions to receive a sequence dataset, extract a feature dataset including a plurality of feature sets and a temporal position encoding dataset including a plurality of individual encoding sets from the sequence dataset, concatenate each of the plurality of feature sets with a corresponding one of the plurality of individual encoding sets to generate a concatenated feature set, implement a trained embedding generation model to generate an embedding based on the concatenated feature set, and store the embedding in an embedding store. The trained embedding generation model comprises a sparse self-attention mechanism.

In various embodiments, a computer-implemented method is disclosed. The computer-implemented method includes steps of receiving a sequence dataset, extracting a feature dataset including a plurality of feature sets and a temporal position encoding dataset including a plurality of individual encoding sets from the sequence dataset, concatenating each of the plurality of feature sets with a corresponding one of the plurality of individual encoding sets to generate a concatenated feature set, implementing a trained embedding generation model to generate an embedding based on the concatenated feature set, and storing the embedding in an embedding store. The trained embedding generation model comprises a sparse self-attention mechanism.

In various embodiments, a non-transitory computer readable medium having instructions stored thereon is disclosed. The instructions, when executed by at least one processor, cause at least one device to perform operations including receiving a sequence dataset, extracting a feature dataset including a plurality of feature sets and a temporal position encoding dataset including a plurality of individual encoding sets from the sequence dataset, concatenating each of the plurality of feature sets with a corresponding one of the plurality of individual encoding sets to generate a concatenated feature set, implementing a trained embedding generation model to generate an embedding based on the concatenated feature set, and storing the embedding in an embedding store. The trained embedding generation model comprises a sparse self-attention mechanism.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide generative artificial intelligence-based embedding generation, in accordance with some embodiments;

FIG. 2 illustrates a computer system configured to implement one or more processes, in accordance with some embodiments;

FIG. 3 is a flowchart illustrating a transformer-based embedding generation method, in accordance with some embodiments;

FIG. 4 is a process flow illustrating various steps of the transformer-based embedding generation method of FIG. 3, in accordance with some embodiments;

FIG. 5 is a flowchart illustrating an embedding-based classification process utilizing a transformer-based embedding generation method, in accordance with some embodiments;

FIG. 6 is a process flow illustrating various steps of the embedding-based classification process of FIG. 5, in accordance with some embodiments;

FIG. 7A is a graph visualization of a feature representation of a plurality of input datasets, in accordance with some embodiments;

FIG. 7B is a graph visualization of an embedding representation of the plurality of input datasets, in accordance with some embodiments;

FIG. 8 is a batch process flow illustrating a batch embedding generation process, in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating computer embeddings. In various embodiments, a transformer-based embedding model is configured to receive an input dataset and generate an output embedding. The transformer-based embedding model is configured to concatenate features and temporal position encoding information and generate one or more embeddings based on the concatenated encodings. In some embodiments, the transformer-based embedding model applies sparse self-attention mechanisms including an enhanced loss function (e.g., entmax function) and a residual model process to output a final embedding. In some embodiments, the generated embedding includes a holistic representation of an entity, e.g., a user, across multiple touchpoints and/or over an extended time period.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

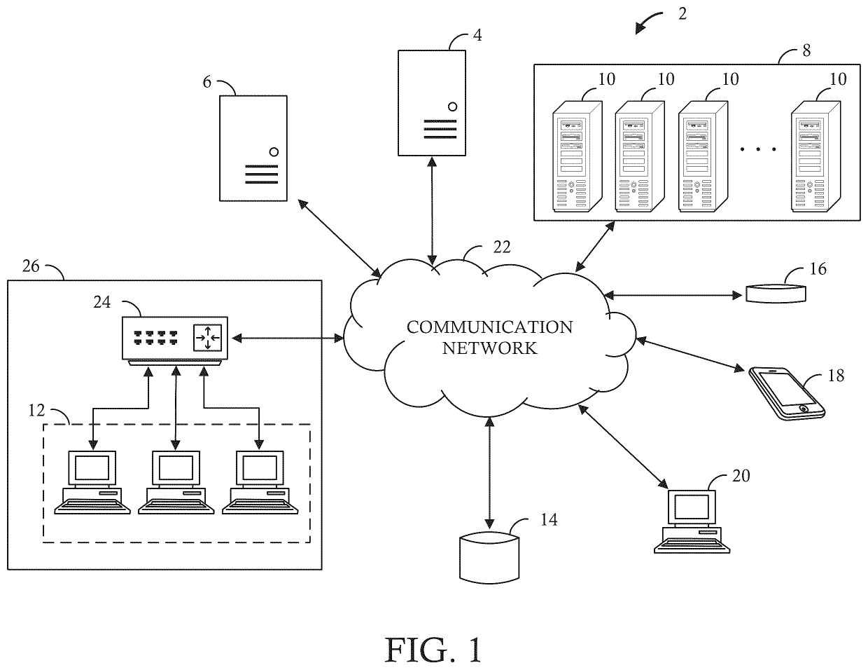

FIG. 1 illustrates a network environment 2 configured to provide generative artificial intelligence-based embedding generation, in accordance with some embodiments. The network environment 2 includes a plurality of devices or systems configured to communicate over one or more network channels, illustrated as a network cloud 22. For example, in various embodiments, the network environment 2 may include, but is not limited to, an embedding generation computing device 4, a web server 6, a cloud-based engine 8 including one or more processing devices 10, workstation(s) 12, a database 14, and/or one or more user computing devices 16, 18, 20 operatively coupled over the network 22. The embedding generation computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the embedding generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the embedding generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the embedding generation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the embedding generation computing device 4, for example. The workstation(s) 12 may communicate with the embedding generation computing device 4 over the communication network 22. The workstation(s) 12 may send data to, and receive data from, the embedding generation computing device 4.

Although FIG. 1 illustrates three user computing devices 16, 18, 20, the network environment 2 may include any number of user computing devices 16, 18, 20. Similarly, the network environment 2 may include any number of the embedding generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the embedding generation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in search results. The website may capture these activities as user session data, and transmit the user session data to the embedding generation computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the embedding generation computing device 4.

In some embodiments, the embedding generation computing device 4 may execute one or more models, processes, or algorithms, such as a machine learning model, deep learning model, statistical model, generative model, etc., to generate embeddings. The embedding generation computing device 4 may transmit generated embeddings to one or more additional systems and/or processes, such as the web server 6, and the additional systems and/or processes may perform additional operations based on the generated embeddings. For example, one or more additional processes may be implemented to compare generated embeddings to identify certain trends and/or characteristics of the underlying data, such as identifying and/or sorting users based on generated user embeddings. As another example, the generated embeddings may be provided to one or more additional machine learning processes, such as machine-learning based classification processes, ranking processes, etc.

The embedding generation computing device 4 is further operable to communicate with the database 14 over the communication network 22. For example, the embedding generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the embedding generation computing device 4, in some embodiments, the database 14 may be a local storage device, such as a hard drive, a non-volatile memory, or a USB stick. The embedding generation computing device 4 may store interaction data received from the web server 6 in the database 14. The embedding generation computing device 4 may also receive from the web server 6 user session data identifying events associated with browsing sessions, and may store the user session data in the database 14.

In some embodiments, the embedding generation computing device 4 generates training data for a plurality of models (e.g., embedding generation models) based on aggregated session data and/or simulated session data. The embedding generation computing device 4 and/or one or more of the processing devices 10 may train one or more models based on corresponding training data. The embedding generation computing device 4 may store the models in a database, such as in the database 14 (e.g., a cloud storage database).

The models, when executed by the embedding generation computing device 4, allow the embedding generation computing device 4 to generate embeddings for received input datasets. For example, the embedding generation computing device 4 may obtain one or more models from the database 14. The embedding generation computing device 4 may then receive, in real-time from the web server 6, session data associated with a specific user, entity, etc. In response to receiving session data, the embedding generation computing device 4 may execute one or more models to generate an embedding representative of the session data or an underlying entity within the session data (e.g., a user).

In some embodiments, the embedding generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, embedding generation computing device 4 may generate classifications, categorizations, and/or other determinations with respect to the generated embeddings.

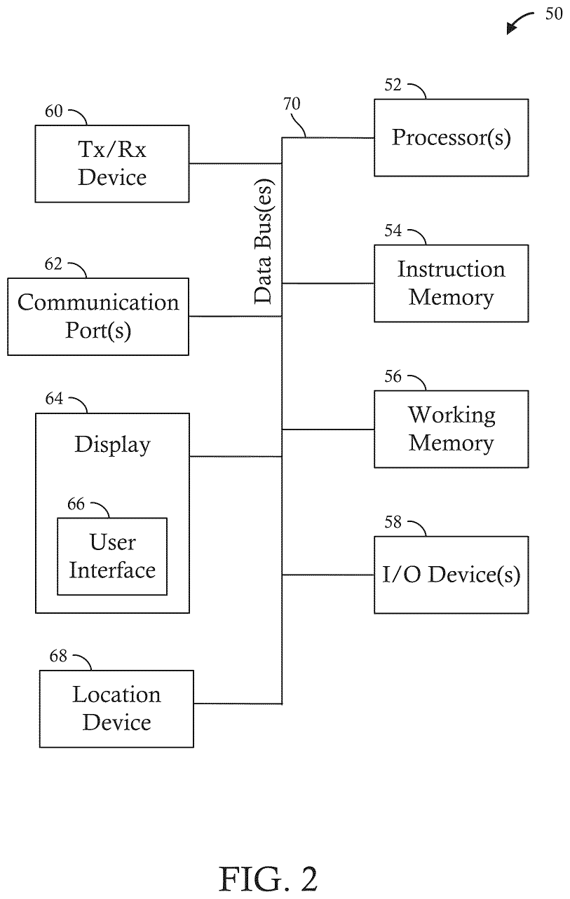

FIG. 2 illustrates a block diagram of a computing device 50, in accordance with some embodiments. In some embodiments, each of the embedding generation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating embeddings and/or classifying entities, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

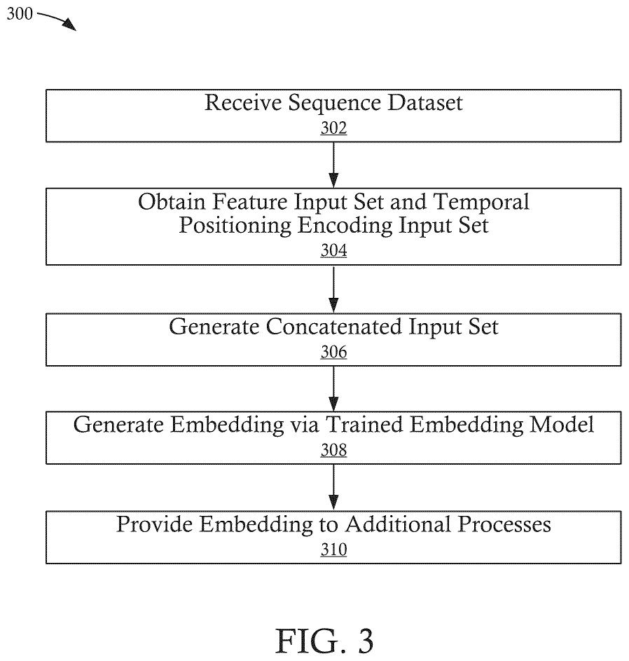

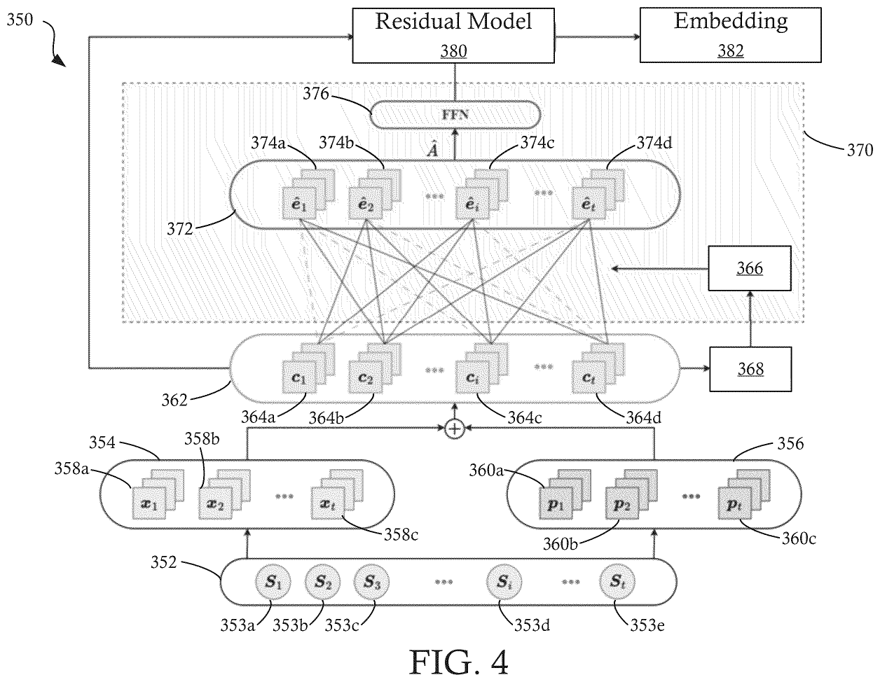

FIG. 3 is a flowchart illustrating a transformer-based embedding generation method 300, in accordance with some embodiments. FIG. 4 is a process flow 350 illustrating various steps of the transformer-based embedding generation method 300, in accordance with some embodiments. At step 302, a sequence dataset 352 is received. The sequence dataset 352 includes data representative of a sequence of events (e.g., interactions, activities, etc.) performed by and/or associated with at least one entity in the network environment. As one non-limiting example, in some embodiments, the sequence dataset 352 includes data representative of user interactions for a first user within and/or in conjunction with a network environment.

At step 304, a feature input set 354 and a temporal position encoding input set 356 are extracted and/or generated from the sequence dataset 352. The feature input set 354 and/or the temporal position encoding input set 356 may be generated by any suitable module, engine, etc., such as, for example, a sequence feature transformation module configured to apply one or more extraction and/or transformation processes to generate the feature input set 354 and/or the temporal position encoding input set 356. The sequence feature transformation module may be configured to sort events in the sequence dataset 352 based on temporal data (e.g. timestamps), extract temporal data, and/or extract features from each of the events in the sequence dataset 352. In some embodiments, the feature input set 354 and/or the temporal position encoding input set 356 are generated by one or more offline processes (not shown).

The feature input set 354 includes individual feature sets 358a-358c each associated with one of the events represented in the sequence dataset 352. Each of the individual feature sets 358a-358c includes a plurality of features that include data representative of one or more aspects of the event, such as user aspects, device aspects, event aspects, network aspects, etc. For example, in embodiments configured to generate user embeddings, an individual feature set 358a-358c may include, but is not limited to, user features (e.g., user ID, user account statistics (e.g., account age, account activity, etc.), user email address, user name, user preference data, etc.), device features (e.g., device ID, device IP or IP related context, device location(s), device address, etc.), event features (e.g., event timestamp, event data, event category, etc.), etc. Although specific embodiments are discussed herein, it will be appreciated that any suitable features may be included an individual feature set 358a-358c and/or utilized by an embedding generation model, as discussed in greater detail below.

In some embodiments, when generating feature data for an entity, the embedding generation computing device 4 may determine, for each feature category, an attribute or value that is identified most often (e.g., a majority attribute). The attribute defined most often in each feature category is stored as part of the corresponding feature data. In some examples, a percentage score is generated for each attribute within a feature category, and the percentage score is stored as part of the feature data. The percentage score is based on a number of times a particular attribute is identified in a corresponding feature category with respect to the number of times any attribute is identified in that feature category.

In some embodiments, the temporal position encoding input set 356 includes individual temporal encoding sets 360a-360c associated each of the events in the sequence dataset 352 and corresponding to each of the individual feature sets 358a-358c in the feature input set 354. The individual temporal encoding sets 360a-360c include a plurality of position encodings (e.g., data representative of the order of an event within the sequence dataset 352) incorporating temporal data (e.g., time stamps, start times, time deltas, etc.) configured to identify a time period associated with corresponding events and/or sub-events in the sequence dataset 352. The temporal encoding sets 360a-360c provide a temporal aspect to positional ordering of the sequence dataset 352 that is otherwise lost when considering only an absolute positional location of a sequence 353a-353e within the sequence dataset 352.

At step 306, a concatenated input set 362 is generated by concatenating each feature in an individual feature set 358a-358c with a corresponding temporal position indicator in each individual temporal encoding set 360a-360c. The concatenated input set 362 includes a plurality of concatenated feature sets 364a-364d. Each of the concatenated feature sets 364a-364d corresponds to a combination of an individual feature 358a-358c and an individual temporal encoding set 360a-360c. Each of the concatenated feature sets 364a-364d may include a plurality of concatenated elements including a feature and a concatenated temporal position identifier.

At step 308, an embedding 382 is generated by providing the concatenated input set 362 to a trained embedding generation model 370. The trained embedding generation model 370 includes a sparse self-attention transformer 372 including one or more sparse self-attention mechanisms 374a-374d. Each of the sparse self-attention mechanism 374a-374d is configured to receive one or more of the concatenated feature sets 364a-364d and apply a subset of computations within a self-attention matrix. The sparse self-attention transformer 372 reduces the complexity of the self-attention mechanism as compared to dense self-attention mechanisms. In contrast to prior self-attention mechanisms utilizing simple positional encoding, which create permutational variance and are unable to handle irregular events, the sparse self-attention transformer 372 utilizes temporal position encoding that is capable of interpreting irregular events within the sequence dataset 352.

In some embodiments, the sparse self-attention transformer 372 is configured to generate a key, a query, and a value for each of the concatenated feature sets 364a-364d. An attention score representative of a level of consideration for each concatenated feature set 364a-364d is generated for each of the key, query, and value combinations. For example, in some embodiments, attention scores for activities indicative of fraudulent and/or anomalous behavior may have a higher attention score as compared to normal and/or approved activities or interactions. Although certain embodiments are discussed herein, it will be appreciated that a sparse self-attention transformer 372 may be configured to apply any suitable weighting based on the concatenated features within each concatenated feature set 364a-364d.

In some embodiments, the sparse self-attention transformer 372 utilizes an enhanced loss function 366 (referred to herein as an “entmax” function). An entmax function may include a modified softmax function tuned (e.g. iteratively adjusted) to apply weights (e.g., attention values) on a selective basis. In contrast to traditional attention mechanisms, which requires the model to assign a weight to each activity or interaction, the entmax function applies weights only to meaningful activities or interactions. The entmax function may include, for example, one or more parameters configured to tune a shape of the loss function (e.g., adjust the loss function from a traditional piecewise linear shape of a softmax function). With respect to a user embedding, in some embodiments, the entmax function is configured to apply weightings to certain irregular events representative of anomalies within the user base. In some embodiments, the enhanced loss function 366 receives an input from a first multilayer perceptron (MLP) 368.

In some embodiments, the trained embedding generation model 370 is configured to generate attention values for two or more of the concatenated features sets 364a-364d in parallel. For example, in some embodiments, the trained embedding generation model 370 includes a head 374a-374d configured to be operated in parallel to generate individual outputs that may be provided to a feed-forward network 376. The feed-forward network 376 is configured to aggregate the outputs of each of the heads 374a-374d into an output 378 of the sparse self-attention transformer 372.

In some embodiments, the output 378 of the sparse self-attention transformer 372 is provided to a residual model 380. The residual model 380 may be configured to receive the concatenated input set 362 and the output 378 and generate an output embedding 382. In some embodiments, the residual model 380 includes a feedforward network, such as a second multilayer perceptron (MLP). Although specific embodiments are discussed herein, it will be appreciated that the residual model 380 may include any suitable model.

In some embodiments, the output embeddings 382 represent a holistic intelligent aggregated representation of entity information (e.g., user data). The output embeddings 382 may be generated in a format (e.g., within a vector representation space) that is compatible with additional models architectures, resulting in improved model accuracy and better performance of those models when utilizing output embeddings 382. The output embeddings 382 provide holistic representations without needing to perform large volumes of feature engineering and/or manual processing, enabling reduced operation costs and improving time to launch for applications utilizing output embeddings 382.

At step 310, the output embedding(s) are provided to one or more additional processes and/or modules. In various embodiments, the output embeddings 382 may be utilized by one or more additional processes and/or downstream applications. For example, and as discussed in greater detail below, a plurality of output embeddings 382 may be utilized for clustering of entities. In one non-limiting example, a plurality of output embeddings 382 representative of users may be clustered for fraud ring analysis. As another non-limiting example, one or more output embeddings 382 may be provided to one or more additional models or processes, such as one or more machine learning models, one or more deep learning models, one or more reinforcement learning models, etc.

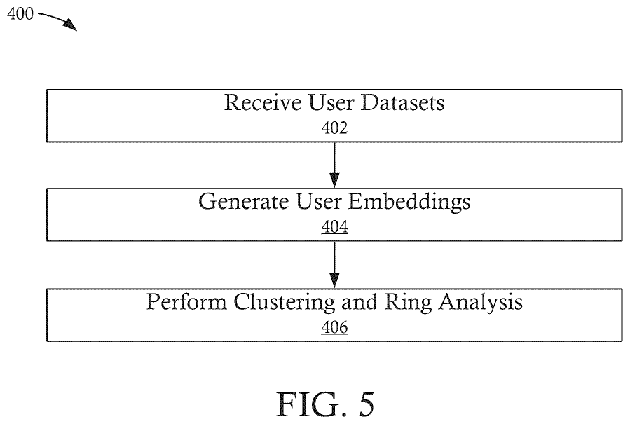

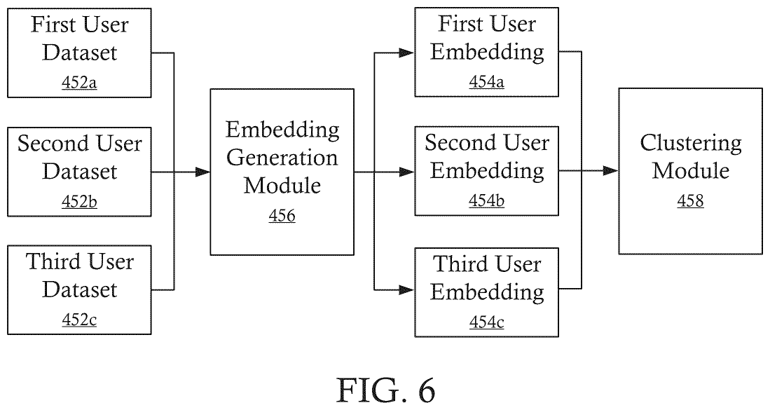

FIG. 5 is a flowchart illustrating an embedding-based classification process 400 utilizing a transformer-based embedding generation method, in accordance with some embodiments. FIG. 6 is a process flow 450 illustrating various steps of the embedding-based classification process 400, in accordance with some embodiments. At step 402, a plurality of user datasets 452a-452c (collectively “user datasets 452”) are received. Each of the user datasets 452a-452c includes data representative of user activities and/or interactions with a network environment. For example, in the context of an ecommerce environment, user datasets 452 may include, but are not limited to, data representative of network activity, user profiles, user interactions, user-associated device profiles, etc. Although specific embodiments are discussed herein, it will be appreciated that any suitable user datasets 452 may be received.

At step 404, a user embedding 454a-454c (collectively “user embeddings 454”) is generated for each of the user datasets 452. The user embedding 454 may be generated by an embedding generation module 456 configured to implement an embedding generation method, such as the transformer-based embedding generation method 300 discussed above. In some embodiments, the embedding generation module 456 includes a trained embedding generation model 370 including a sparse self-attention transformer 372. The plurality of user embeddings 454 may be provided directly to a subsequent module and/or may be stored in a database, such as, for example, database 14a.

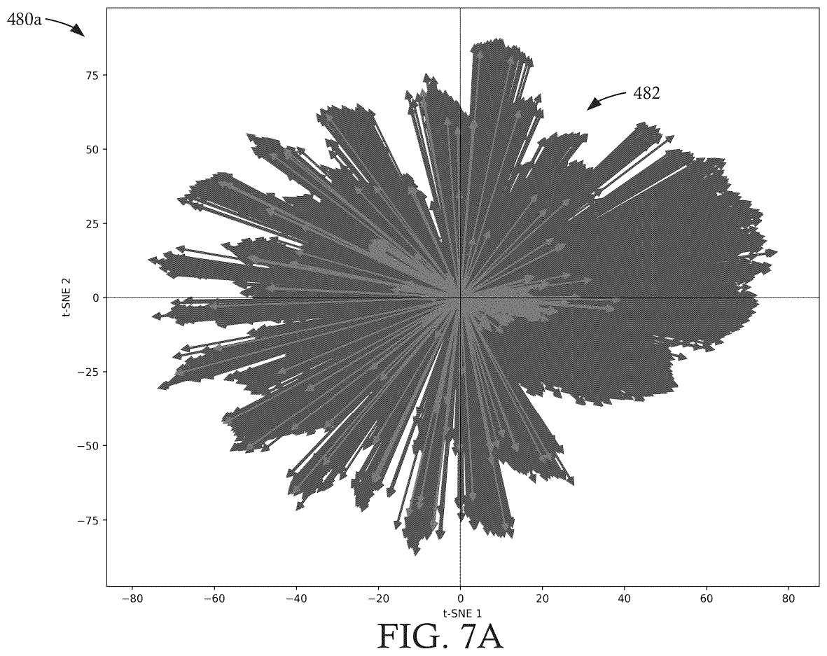

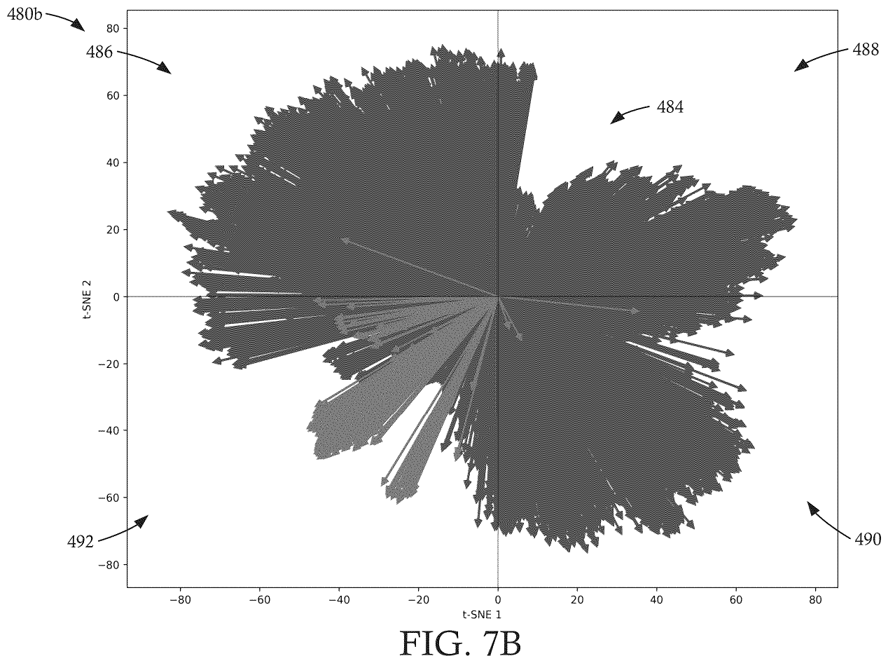

At step 406, a clustering module 458 is configured to project each of the plurality of user embeddings 454 into the corresponding vector embedding space and perform ring analysis to identify anomalous users. For example, in some embodiments, anomalous users may include users engaging in fraudulent and/or undesirable behaviors. Clustering of the plurality of user embeddings 454 may provide for identification of specific groups of users based on position and/or corresponding clusters for each of the plurality of user embeddings. For example, FIG. 7A is a graph visualization 480a of a feature representation 482 of a plurality of user datasets and FIG. 7B is a graph visualization 480b of an embedding representation 484 of the plurality of user datasets, in accordance with some embodiments. As shown in FIG. 7A, when projected into a corresponding feature space, the user datasets are mixed and chaotic, with no clear groupings or clustering of individual user datasets. In contrast, user embeddings generated according to the disclosed systems and methods herein, when projected into a corresponding vector embedding space, include clear groupings of users. In the illustrated example, the majority of the user embeddings being projected into the upper left quadrant 486, upper right quadrant 488, and lower right quadrant 490 may represent users engaged in fraudulent or undesirable behavior and a cluster or majority of the user embeddings being projected into the lower left quadrant 492 may represent users engaged in approved or normal behavior. Although specific embodiments are discussed herein, it will be appreciated that embeddings may be generated according to the disclosed systems and methods including attention (e.g., focus) on any suitable features, behaviors, activities, etc.

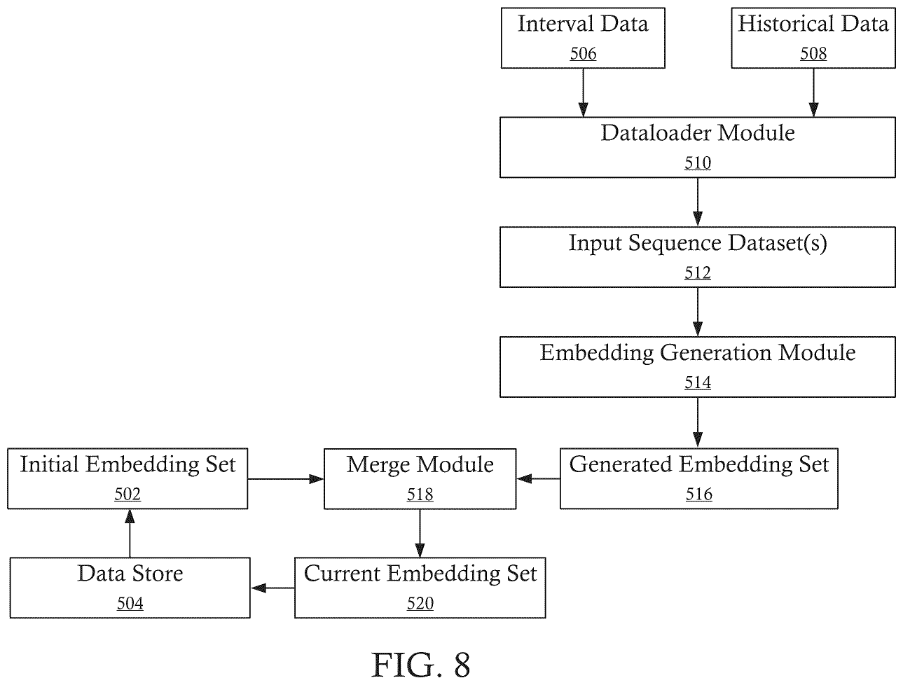

Generation of embeddings, such as user embeddings, may be time and resource intensive. In some embodiments, a batch process flow 500, such as illustrated in FIG. 8, may be implemented to reduce time and resource requirements for embedding generation, in accordance with some embodiments. An initial set of embeddings 502, such as user embeddings, may be generated according to any suitable process, such as, for example, the transformer-based embedding generation method 300 discussed above. The initial set of embeddings may be stored in any suitable storage mechanism, such as, for example, a data store 504 (e.g., a database, heap, etc.). The initial set of embeddings 502 may be generated using data, such as user data, encompassing a first time period, such as a month, a year, etc.

At a predetermined interval, such as, for example, once a day, once a week, etc., interval data 506 including sequence data for one or more entities, e.g., users, including activities and/or interactions performed within the predetermined interval period. For example, if the predetermined interval is daily, interval data 506 will include sequence data for a time period consisting of the prior day. Interval data 506 includes one or more sequence datasets for one or more entities. The interval data 506 may be obtained by any suitable process, such as, for example, a data pipeline configured to generate one or more notifications and/or data processing notifications when interval data 506 is generated and/or obtained.

Historical data 508 is also obtained for a predetermined number of prior intervals for each entity, e.g., user, represented in the interval data 506. The predetermined number of prior intervals may include a number of prior intervals sufficient to fill out a time period having the same length as the first time period utilized to generate the initial set of embeddings 502. For example, if the initial time period was one year, and the predetermined interval is one day, the predetermined number of prior intervals may be 364 days to complete a time period having the same length as the initial time period (e.g., 1 day (predetermined interval)+364 days (prior intervals) is 365 days or one year). Although specific embodiments are discussed herein, it will be appreciated that any suitable intervals and/or number of intervals may be utilized for the initial interval, predetermined interval, and/or the predetermined number of prior intervals.

The interval data 506 and the historical data 508 is provided to a dataloader module 510. The dataloader module 510 is configured to generate input sequence datasets 512 including sequence data for each entity represented in the interval data. The generated input sequence datasets 512 include each of the activities and/or interactions of a corresponding entity within the interval data 506 and the historical data 508, e.g., an input sequence dataset including activities over a time period having the same length as the initial time period, such as, for example one year. The time period of the generated input sequence datasets 512 encompasses the current interval period corresponding to the interval data 506.

The generated input sequence datasets 512 are provided to an embedding generation module 514 configured to generate one or more generated embeddings 516. The embedding generation module 514 may be configured to implement an embedding generation method, such as the transformer-based embedding generation method 300 discussed above. In some embodiments, the embedding generation module 514 includes a trained embedding generation model 370 including a sparse self-attention transformer 372. The generated embeddings 516 include embeddings only for those entities represented in the interval data 506.

A merge module 518 is configured to merge the initial set of embeddings 502 and the one or more generated embeddings 516 to generate a current embedding set 520. For example, in some embodiments, the merge module 518 is configured to replace embeddings in the initial set of embeddings associated one or more entities with embeddings in the generated embeddings 516 for the corresponding one or more entities. As another example, in some embodiments, a new version of an embedding may be added for an entity while maintaining one or more prior versions of an embedding for the entity. The current embedding set 520 may be stored in a data store 504, for example, replacing and/or supplementing the previously generated embeddings stored in the data store 504.

It will be appreciated that generation of embeddings and implementation of models utilizing generated embeddings as disclosed herein, particularly on large datasets intended to be used large network environments such as ecommerce environments, is only possible with the aid of computer-assisted machine-learning algorithms and techniques, such as the embedding generation models 370 disclosed herein. In some embodiments, machine learning processes including embedding generation models are used to perform operations that cannot practically be performed by a human, either mentally or with assistance, such as clustering, fraud detection, risk score determination, automated recommendations, etc. It will be appreciated that a variety of machine learning techniques can be used alone or in combination based on generated embeddings as disclosed herein.

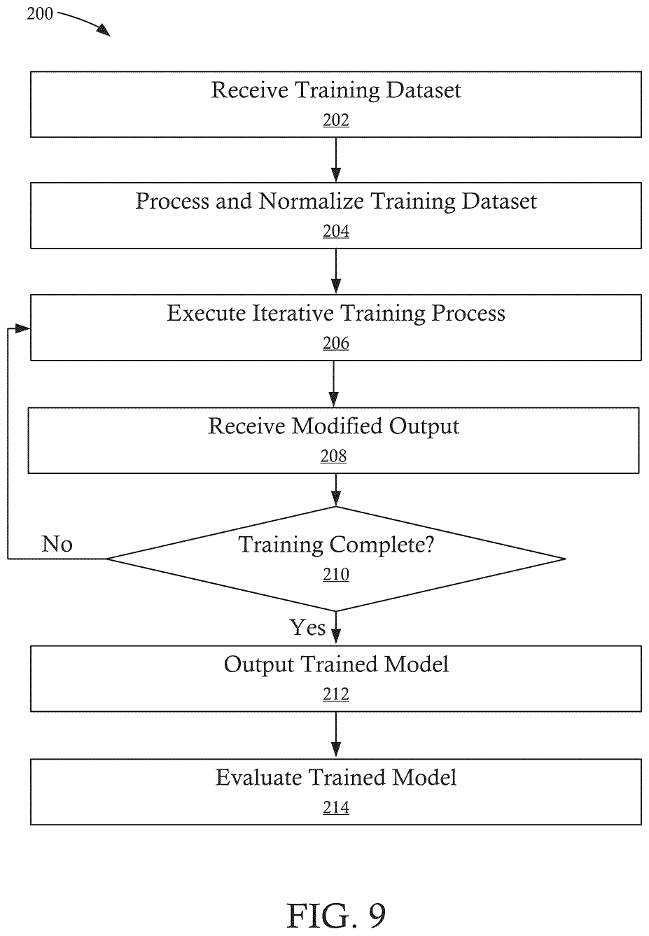

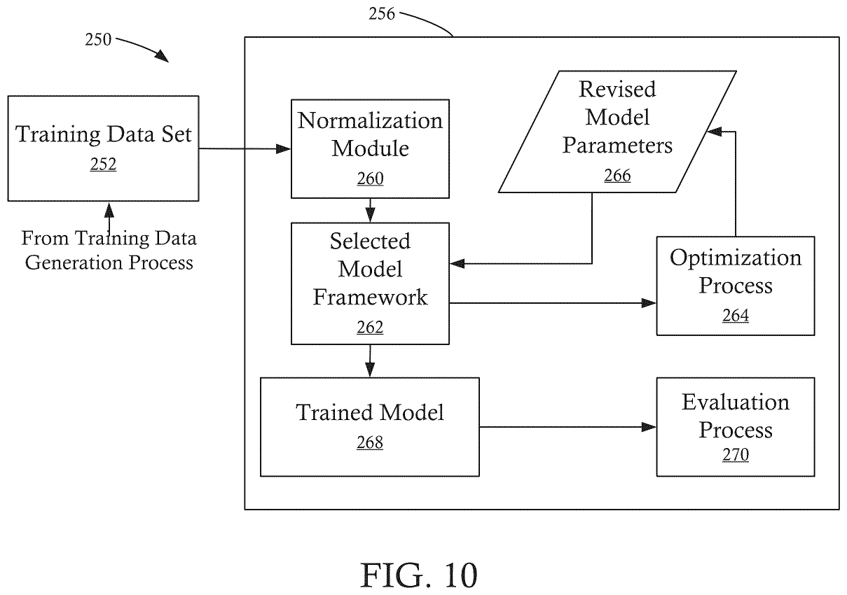

In some embodiments, one or more trained models can be generated using an iterative training process based on a training dataset. FIG. 9 illustrates a method 200 for generating a trained model, such as a trained optimization model, in accordance with some embodiments. FIG. 10 is a process flow 250 illustrating various steps of the method 200 of generating a trained model, in accordance with some embodiments. At step 202, a training dataset 252 is received by a system, such as a processing device 10. The training dataset 252 can include sequence data from historical interactions.

At optional step 204, the received training dataset 252 is processed and/or normalized by a normalization module 260. For example, in some embodiments, the training dataset 252 can be augmented by imputing or estimating missing values of one or more features associated with embedding generation. In some embodiments, processing of the received training dataset 252 includes outlier detection configured to remove data likely to skew training of an embedding generation model. In some embodiments, processing of the received training dataset 252 includes removing features that have limited value with respect to training of the embedding generation model.

At step 206, an iterative training process is executed to train a selected model framework 262. The selected model framework 262 can include an untrained (e.g., base) machine learning model, such as a sparse self-attention mechanism and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the selected model framework 262 includes an enhanced loss function, such as, for example, an entmax function.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268, such as a trained embedding generation model, is output and provided for use in a embedding generation and/or other processes. At optional step 212, a trained model 268 can be evaluated by an evaluation process 270. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions that, when executed, cause the processor to:
receive a sequence dataset;
extract a feature dataset including a plurality of feature sets and a temporal position encoding dataset including a plurality of individual encoding sets from the sequence dataset;
concatenate each of the plurality of individual encoding sets with a corresponding one of the plurality of feature sets to generate a concatenated feature set;
generate an embedding based on the concatenated feature set, wherein the embedding is generated by an embedding generation model including a sparse self-attention mechanism; and
store the embedding in an embedding store.

2. The system of claim 1, wherein the each of the plurality of feature sets is representative of an event in the sequence dataset.

3. The system of claim 2, wherein each of the plurality of individual encoding sets is associated with the event in the sequence dataset for the corresponding one of the plurality of feature sets.

4. The system of claim 1, wherein the sparse self-attention mechanism comprises a sparse self-attention transformer including an enhanced loss function.

5. The system of claim 1, wherein the embedding generation model generates a key, a query, and a value for each concatenated feature set.

6. The system of claim 1, wherein the embedding generation model comprises a residual model that receives an output of the sparse self-attention mechanism and the concatenated feature set and generates the embedding.

7. The system of claim 1, wherein each of the plurality of feature sets includes a majority attribute.

8. A computer-implemented method, comprising:
receiving a sequence dataset;
extracting a feature dataset including a plurality of feature sets and a temporal position encoding dataset including a plurality of individual encoding sets from the sequence dataset;
concatenating each of the plurality of individual encoding sets with a corresponding one of the plurality of feature sets to generate a concatenated feature set;
generating an embedding based on the concatenated feature set, wherein the embedding is generated by an embedding generation model comprising a sparse self-attention mechanism; and
storing the embedding in an embedding store.

9. The computer-implemented method of claim 8, wherein the each of the plurality of feature sets is representative of an event in the sequence dataset.

10. The computer-implemented method of claim 9, wherein each of the plurality of individual encoding sets is associated with the event in the sequence dataset for the corresponding one of the plurality of feature sets.

11. The computer-implemented method of claim 8, wherein the sparse self-attention mechanism comprises a sparse self-attention transformer including an enhanced loss function.

12. The computer-implemented method of claim 8, wherein the embedding generation model generates a key, a query, and a value for each concatenated feature set.

13. The computer-implemented method of claim 8, wherein the embedding generation model comprises a residual model that receives an output of the sparse self-attention mechanism and the concatenated feature set and generates the embedding.

14. The computer-implemented method of claim 8, wherein each of the plurality of feature sets includes a majority attribute.

15. A non-transitory computer-readable medium having instructions stored thereon, wherein the instructions, when executed by at least one processor, cause at least one device to perform operations comprising:
receiving a sequence dataset;
extracting a feature dataset including a plurality of feature sets and a temporal position encoding dataset including a plurality of individual encoding sets from the sequence dataset;
concatenating each of the plurality of individual encoding sets with a corresponding one of the plurality of feature sets to generate a concatenated feature set;
generating an embedding based on the concatenated feature set, wherein the embedding is generated by an embedding generation model comprising a sparse self-attention mechanism; and
storing the embedding in an embedding store.

16. The non-transitory computer-readable medium of claim 15, wherein the each of the plurality of feature sets is representative of an event in the sequence dataset, and wherein each of the plurality of individual encoding sets is associated with the event in the sequence dataset for the corresponding one of the plurality of feature sets.

17. The non-transitory computer-readable medium of claim 15, wherein the sparse self-attention mechanism comprises a sparse self-attention transformer including an enhanced loss function.

18. The non-transitory computer-readable medium of claim 15, wherein the embedding generation model generates a key, a query, and a value for each concatenated feature set.

19. The non-transitory computer-readable medium of claim 15, wherein the embedding generation model comprises a residual model that receives an output of the sparse self-attention mechanism and the concatenated feature set and generates the embedding.

20. The non-transitory computer-readable medium of claim 15, wherein each of the plurality of feature sets includes a majority attribute.
